(19) United States
(12) Patent Application Publication
(10) Pub. No.: US 2018/0285867 A1
(43) Pub. Date: Oct. 4, 2018

(54) DISTRIBUTED AUDITING METHOD, DEVICE AND SYSTEM

(71) Applicant: Tidetime Sun Ltd., Chai Wan (HK)

(72) Inventor: Gwan-Hwan Hwang, Hsinchu County (TW)

(21) Appl. No.: 15/686,453

(22) Filed: Aug. 25, 2017

(30) Foreign Application Priority Data
Mar. 28, 2017 (TW) 106110394

(51) Int. Cl. G06Q 20/40; H04L 9/06; G06Q 20/38

(52) U.S. Cl. CPC G06Q 20/401; G06Q 20/3827; H04L 9/0643

(57) ABSTRACT

A distributed auditing method includes the steps of providing a to-be-audited information stored by using a hash tree method, wherein the to-be-audited information is related to a plurality of user ends; utilizing a processor, creating a condensed status code according to the to-be-audited information by using a hash function; corresponding to the user ends, creating a plurality of slices according to the to-be-audited information; providing the condensed status code and each of the plurality of slices to each of the corresponding plurality of user ends respectively; and auditing the to-be-audited information according to feedbacks from each of the plurality user ends. A distributed auditing device and its system are also disclosed.

### BACKGROUND OF THE INVENTION

### Field of the Invention

The present invention is related to the field of network and auditing, in particular, to a distributed auditing method, a device and a system.

### Description of Related Art

Different from the sales of traditional printed articles or physical optical disks, a variety of application programs nowadays, such as games, books or media products, can all be digitized and virtualized in devices of computers or smartphones etc., which can be browsed or used online or after downloading thereof. The aforementioned digital products may be associated to patent rights, trademark rights, copyrights or a combination of such rights. To expand the sales channel, the owner of such digital products may entrust agents or authorized agents to perform sales on network platforms of the agents. In addition, the agents may also carry numerous products of the owner in order to increase the diversity of products and to further increase the consumer willingness of users.

Accordingly, different authorization contracts may be established between the owner and the agent. For example, the number of downloads of the products of the owner purchased by users from the agent's platform may be statistically analyzed for a certain period of time, and subsequently, the agent can then calculate the royalty based on the number of downloads and a certain percentage agreed in order to make payment to the owner, which is known as the payment distribution. Therefore, the agent is responsible for collecting fees from users, recording and statistically calculating accounts; furthermore, an account balance record is provided to the owner for a period of time in order to form the owner about the download records of the product during such period of time and the corresponding royalty etc.

However, since the aforementioned account is recorded and maintained by the agent, the owner has no way to perform audits to verify its authenticity. For example, the agent may deliberately and intentionally forge or alter records in order to reduce the royalty to be paid to the owner. Moreover, the agent may even claim that certain downloads have been made by illegal users through illegal methods such as cracking and hacking such that the number of downloads shall not be recognized, and no payment to the owner is made.

Under the condition where owner cannot audit the authenticity of the account, not only the rights and interests of the owner may be damaged, but also the willingness of the owner to authorize agents for the sales of products may be reduced, which is disadvantageous to the development of network platform sales.

Therefore, the present invention provides a distributed auditing method, device and system to overcome the aforementioned problem.

### SUMMARY OF THE INVENTION

According to one aspect of the present invention, a distributed auditing method is provided, and the method comprises: providing a to-be-audited information stored by using a hash tree method, wherein the to-be-audited information is related to a plurality of user ends; utilizing a processor to create a condensed status code according to the to-be-audited information by using a hash function; corresponding to the user ends, creating a plurality of slices according to the to-be-audited information; providing the condensed status code and each of the plurality of slices to each of the corresponding plurality of user ends respectively; and auditing the to-be-audited information according to feedbacks from each of the plurality user ends.

According to a preferred embodiment of the present invention, the distributed auditing method further comprises placing the condensed status code in a blockchain.

According to a preferred embodiment of the present invention, wherein the hash function refers to a SHA series of hash function.

According to a preferred embodiment of the present invention, wherein the hash tree refers to a full hash binary tree.

According to another aspect of the present invention, a distributed auditing device is provided, and the device comprises: a storage module for providing a to-be-audited information stored by using a hash tree method, wherein the to-be-audited information is related to a plurality of user ends; a status code processing module for creating a condensed status code according to the to-be-audited information by using a hash function; a slice module for creating a plurality of slices according to the to-be-audited information, corresponding to the user ends; a transmission module for providing the condensed status code and each of the plurality of slices to each of the corresponding plurality of user ends respectively; a reception module for receiving feedbacks of each of the plurality of user ends; an auditing module for auditing the to-be-audited information according to the feedbacks; and a processor coupled to the storage module, the status code processing module, the slice module, the transmission module, the reception module and the auditing module, and used for executing operations of the distributed auditing device.

According to a preferred embodiment of the present invention, wherein the transmission module is further configured to place the condensed status code in a blockchain.

According to a preferred embodiment of the present invention, wherein the hash function refers to a SHA series of hash function.

According to a preferred embodiment of the present invention, wherein the hash tree refers to a full hash binary tree.

According to still another aspect of the present invention, a distributed auditing system is provided, and the system comprises: a distributed auditing device according to any one of the aforementioned aspects; and a plurality of user ends for receiving the condensed status code and each of the plurality of slices and for feeding back to the distributed auditing device.

According to a preferred embodiment of the present invention, wherein devices of the plurality of user ends comprise personal computers, notebook computers, tablet computers, servers, workstations, smartphones, set-top boxes or a combination thereof.

### BRIEF DESCRIPTION OF DRAWING

FIG. 1 is a schematic view of a distributed auditing system according to an embodiment of the present invention;

FIG. 2 is a schematic view of a distributed auditing device according to an embodiment of the present invention;

FIG. 3 is a schematic view of a distributed auditing system according to an embodiment of the present invention;

FIG. 4A is a schematic view of the full hash binary tree according to an embodiment of the present invention; and

FIG. 4B shows a schematic view of a slice of the full hash binary tree.

### DETAILED DESCRIPTION OF THE INVENTION

To illustrate the technical content, structural characteristics of the present invention as well as the objectives and technical effects thereof achieved, the following provides a detailed description of embodiments of the present invention along with the accompanied drawings.

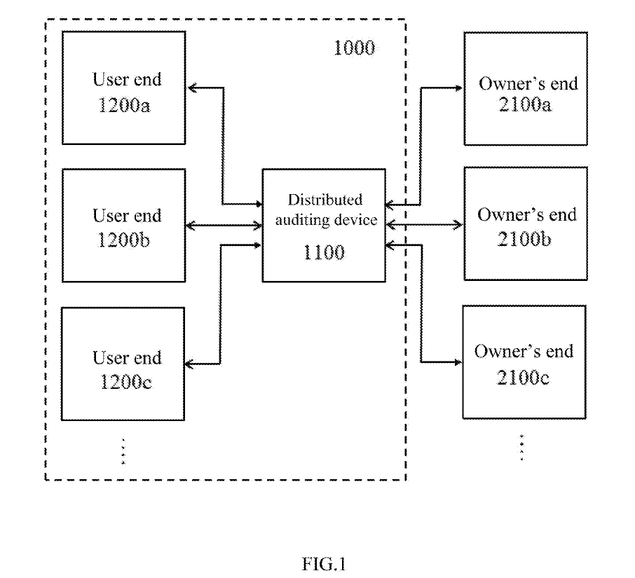

FIG. 1 shows a schematic view of a distributed auditing system according to an embodiment of the present invention. As shown in FIG. 1, a distributed auditing system 1000 comprises: a distributed auditing device 1100; and a plurality of user ends 1200a˜c (quantity is provided for illustration only). The distributed auditing device 1100 can be realized by using a personal computer, notebook computer, server, workstation, other electronic device or a combination thereof. The user ends 1200a˜c can be realized by using personal computers, notebook computers, tablet computers, servers, workstations, smartphones, set-top boxes, other electronic devices or a combination thereof. In addition it can be realized by utilizing a multiple of devices in parallel processing, and it can be equipped with the backup function. The distributed auditing device 1100 and the user ends 1200a˜c can be connected with each other via wired or wireless network. Furthermore, selectively, the distributed auditing device 1110 can also utilize wired or wireless network to connect to a plurality of owner's ends 2100a˜c (quantity is provided for illustration only). Moreover, the term “audit” or “auditing” refers to observations at different functional aspects, which shall not be referred to as inspection, confirmation or verification etc.

As shown in FIG. 1, the owner's ends 2100a˜c can authorize different copyright products to the distributed auditing device 1100 for agency sales and for providing to the user ends 1200a˜c. In other words, the distributed auditing device 1100 can act as an agent for providing the network sales platform to the user ends 1200a˜c. For example, the owner's end 2100a can be a film provider authorizing a multiple film sources to the operator of the distributed auditing device 1100, such as a random media provider. The distributed auditing device 1100 can provide a website or an application program interface etc. to allow the user ends 1200a˜c to login from a computer, set-top box or smartphone in order to view various films, and after the user clicks and confirms the purchase, the user can then view online or download the film for viewing. The distributed auditing device 1100 then records the number of downloads, fee charged each time etc. of the user ends 1200a˜c, and store the same as the transaction records. The distributed auditing device 1100 then gathers the transaction records of each of the user ends 1200a˜c, which is known as the account and referred to as the to-be-audited information. Accordingly, the owner's ends 2100a˜c can respectively authorize, including but not limited to, application programs, games, books or media products. In addition, the transaction of the user ends 1200a˜c can include but not limited to clicking, browsing, downloading or other methods. It allows the authorization and fee calculation methods specified in the contract between the involved parties.

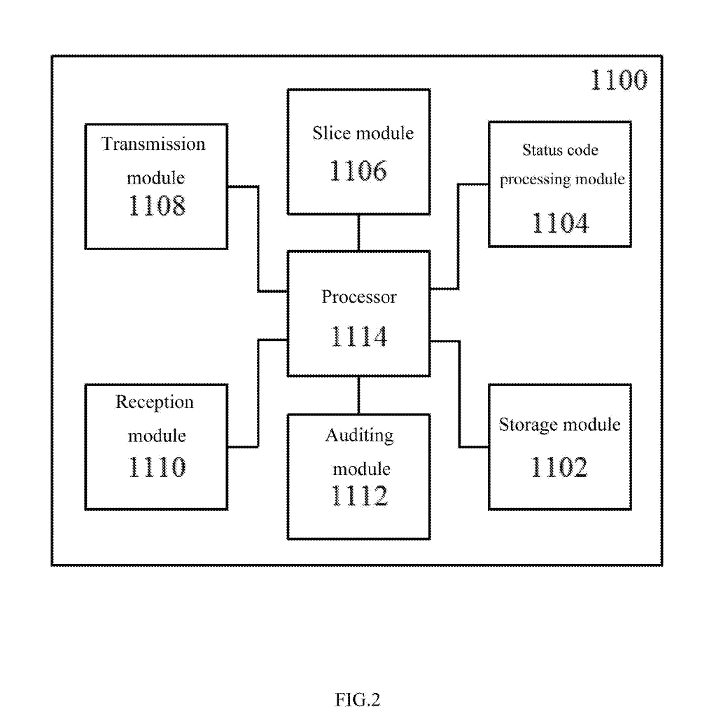

FIG. 2 shows a schematic view of a distributed auditing device according to an embodiment of the present invention. As shown in FIG. 2, the distributed auditing device 1100 comprises: a storage module 1102 for providing a to-be-audited information stored by using a hash tree method, wherein the to-be-audited information is related to a plurality of user ends 1200a˜c; a status code processing module 1104 for creating a condensed status code according to the to-be-audited information by using a hash function; a slice module 1106 for creating a plurality of slices according to the to-be-audited information, corresponding to the user ends; a transmission module 1108 for providing the condensed status code and each of the plurality of slices to each of the corresponding plurality of user ends 1200a˜c, respectively; a reception module 1110 for receiving feedbacks of each of the plurality of user ends 1200a˜c; an auditing module 1112 for auditing the to-be-audited information according to the feedbacks; and a processor 1114 coupled to the storage module 1102, the status code processing module 1104, the slice module 1106, the transmission module 1108, the reception module 1110 and the auditing module 1112, and used for executing operations of the distributed auditing device 1100.

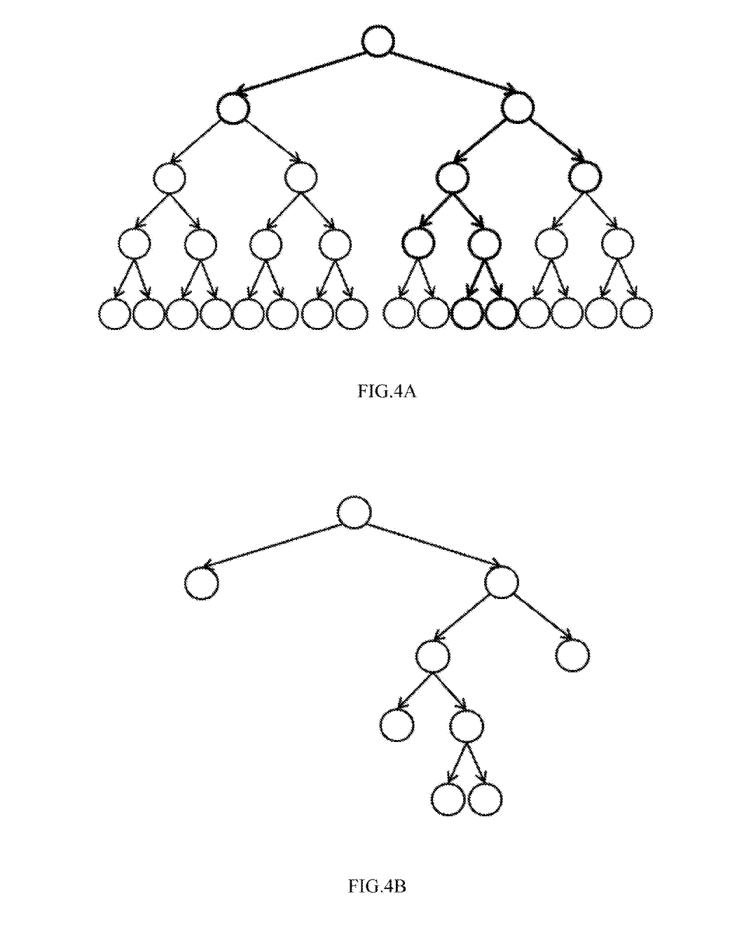

As shown in FIG. 2, the storage module 1102 can be a hard drive, floppy drive, magnetic tape, memory card or other types of built-in or external storage media. The storage module 1102 is able to store a to-be-audited information stored by using a hash tree method, wherein the to-be-audited information is related to the plurality of user ends 1200a˜c. Accordingly, the to-be-audited information, such as an account, records the transaction records of each user end 1200a˜c. In different embodiments, the quantity of the user ends can be extremely large, such as a network sales platform applied to 500,000 user ends. To increase the operation speed, in an embodiment of the present invention, the hash tree method is used to store the to-be-audited information. Furthermore, in a preferred embodiment, the method of full hash binary tree is used, as shown in FIG. 4A. However, in other embodiments, it is not limited to such method only and other hash tree may be used.

As shown in FIG. 2, the status processing module 1104 is used for creating a condensed status code according to the to-be-audited information by using a hash function. The hash function can utilize “MD5”, “RIPEMD160”, “SHA1”, “SHA256”, “SHA384”, “SHA512” or other hash functions. In a preferred embodiment, the SHA series of hash function is utilized, and to be more specific, it can use the “SHA256” hash function. Accordingly, the condensed status code can be used for checking the integrity and identity of the to-be-audited information, and it is of the irreversible properly such that the original data cannot be reversely obtained. Moreover, through condensation, it is of the effect of a compressed file such that it is facilitated for transmission.

As shown in FIG. 2, the slice module 1106 is used for creating a plurality of slices according to the to-be-audited information, corresponding to the plurality of user ends 1200a˜c. In addition, please refer to FIG. 4B, showing a schematic view of the slice. It indicates the hash tree with particular portion extracted. Accordingly, the slice module 1106 is able to create slice related to the user end 1200a according to the user end 1200a, create slice related to the user end 1200b according to the user end 1200b and create slice related to the user end 1200c according to the user end 1200c. Therefore, with each slice, each use can review only his or her own transaction information.

As shown in FIG. 2, a transmission module 1108 is used for providing the condensed status code and each of the plurality of slices to each of the corresponding plurality of user ends 1200a˜c, respectively; a reception module 1110 is used for receiving feedbacks of each of the plurality of user ends 1200a˜c; an auditing module 1112 is used for auditing the to-be-audited information according to each of the feedbacks. Accordingly, for example, the transmission module 1108 is able to transmit the condensed status code and slice related to the user end 1200a to the user end 1200a, transmit the condensed status code and slice related to the user end 1200b to the user end 1200b and transmit the condensed status code and slice related to the user end 1200c to the user end 1200c. Therefore, the user end 1200a is able to determine whether its slice is of identity based on the condensed status code in order to audit whether the transaction information of the user end 1200a is correct and to further determine whether to make feedbacks for errors. The user ends 1200b and 1200c can audit whether the transaction information is erroneous based on their own condensed status codes and slices thereof in order to determine whether to make feedbacks for errors. Accordingly, since each user end 1200a˜c only uses its own slice, it only audits whether its own transaction record is correct. Furthermore, in an embodiment of the present invention, since the condensed status code is utilized such that there is identity, or uniqueness, between each slice and the to-be-audited information, consequently, binding effect exists therebetween. As a result, as long as any one of the user ends 1200a˜c makes a feedback for error, it is able to audit that the to-be-audited information in incorrect. In other words, the auditing work is distributed to each of the user ends 1200a˜c. In addition, when each user end 1200a˜c is reviewing its own transaction record, he or she has also performed the auditing work at the same time without increasing the burden of each user end 1200a˜c. Furthermore, in a preferred embodiment, the confirmation action on the condensed status code and its slice can also be automatically performed by utilizing application program in each one of the user ends 1200a˜c.

In an embodiment of the present invention, the utilization of the condensed status code and slice can greatly reduce the data transmission volume required. For example, in an embodiment, if there are 500,000 user ends, then the memory space required for the installation of hash tree is approximately 206.9 Megabytes (MB), whereas the user end condensed status code requires the download size of only approximately 32 Byes (B) and receiving slice requires the download size of only 1 Kb. The download size is only approximately 1/100,000 of the original account (to-be-audited information). In addition, under an ideal condition, the audit requires only the duration of time of approximately 1/1,000 second. It is applicable to network platform (or known as the network sales platform, network service platform or other names) with large amount of users without obvious lag or improper user experience. Therefore, it is able to achieve a low-burden and high efficiency system.

As shown in FIG. 2, the auditing module 1112 is used for auditing the to-be-audited information according to each one of the feedbacks. When the auditing module 1112 receives the feedback of any one user end, it can the perform auditing process based on such feedback, such as performing classification, statistics or other auditing or reviewing or other handling actions, and it is also able to notify the owner's ends 2100a˜c.

As shown in FIG. 2, the processor 1114 is coupled to the storage module 1102, the status code processing module 1104, the slice module 1106, the transmission module 1108, the reception module 1110 and the auditing module 1112, and it is used for executing operations of the distributed auditing device 1100. Accordingly, the distributed auditing device 1110 can include a combination of software, hardware and firmware, and it can also include computer readable program codes such that it can be stored in memories in order to facilitate the processor 114 to perform the aforementioned actions after accessing the memories.

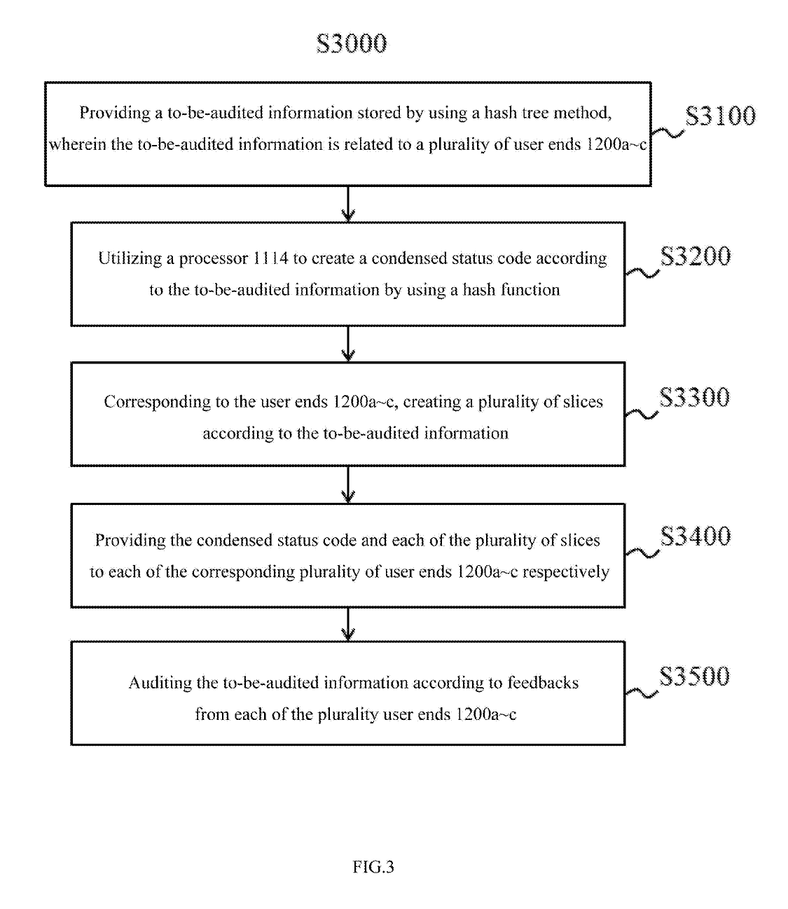

FIG. 3 shows a schematic view of a distributed auditing system according to an embodiment of the present invention. As shown in FIG. 3, the distributed auditing method S3000 comprises: providing a to-be-audited information stored by using a hash tree method, wherein the to-be-audited information is related to a plurality of user ends 1200a˜c (Step S3100); utilizing a processor 1114 to create a condensed status code according to the to-be-audited information by using a hash function (Step S3200); corresponding to the user ends 1200a˜c, creating a plurality of slices according to the to-be-audited information (Step S3300); providing the condensed status code and each of the plurality of slices to each of the corresponding plurality of user ends 1200a˜c respectively (Step S3400); and auditing the to-be-audited information according to feedbacks from each of the plurality user ends 1200a˜c (Step S3500).

In a preferred embodiment, selectively, the condensed status code can be placed in a blockchain in order to utilize a series of cryptography methods to generate associated data blocks such that the validity and counterfeit of the information can be verified; therefore, the condensed status code cannot be modified. In a different embodiment, the condensed status can also be announced via different channels. In a preferred embodiment, with the utilization of the system of the present invention, it is advantageous than the method of directly placing the to-be-audited information (such as account) in the blockchain. Since if the agent places into the incorrect account at the first place, then the blockchain can only ensure that such “incorrect account” is not modified, but the owner's ends 2100a˜c still cannot audit the accuracy of such account. In comparison, with the utilization of the system of the embodiment of the present invention, the to-be-audited information (such as account) is distributed to each user ends 1200a˜c for auditing, and it is ensured that each user end 1200a˜c audits a portion of the information of the same account; as long as nay one user end 1200a˜c audits to find incorrect information, it can then make feedbacks for errors. It shall be noted that a person skilled in art in this field can understand that the to-be-audited information recited here refers to the so-called account information or other information to be audited. In addition, the account information can include the transaction records, such as the number of times of clicking, browsing and downloads etc. or the time thereof and corresponding fee collections, which can also include the amount to be distributed by the agents for payment to the owner. Furthermore, it can have classification or statistics etc. according to the different quantity of users or owners. Moreover, accounting techniques can be further integrated into the method for adjustments, and it can be increased or revised according to the actual needs.

It can be understood that although the present invention has been illustrated with preferred embodiments as disclosed above, such embodiments shall not be used to limit the present invention. Any person skilled in the art in this field is able to make modifications and refinements without deviating the spirit and scope of the present invention. Therefore, the scope of the present invention shall be based on the claims recited hereafter.

What is claimed is:

1. A distributed auditing method, comprising:
providing a to-be-audited information stored by using a hash tree method, wherein the to-be-audited information is related to a plurality of user ends;
utilizing a processor to create a condensed status code according to the to-be-audited information by using a hash function;
corresponding to the user ends, creating a plurality of slices according to the to-be-audited information;
providing the condensed status code and each of the plurality of slices to each of the corresponding plurality of user ends respectively; and
auditing the to-be-audited information according to feedbacks from each of the plurality user ends.

2. The method according to claim 1, further comprising placing the condensed status code in a blockchain.

3. The method according to claim 1, wherein the hash function refers to a SHA series of hash function.

4. The method according to claim 1, wherein the hash tree refers to a full hash binary tree.

5. A distributed auditing device, comprising:
a storage module for providing a to-be-audited information stored by using a hash tree method, wherein the to-be-audited information is related to a plurality of user ends;
a status code processing module for creating a condensed status code according to the to-be-audited information by using a hash function;
a slice module for creating a plurality of slices according to the to-be-audited information, corresponding to the user ends;
a transmission module for providing the condensed status code and each of the plurality of slices to each of the corresponding plurality of user ends respectively;
a reception module for receiving feedbacks of each of the plurality of user ends;
an auditing module for auditing the to-be-audited information according to the feedbacks; and
a processor coupled to the storage module, the status code processing module, the slice module, the transmission module, the reception module and the auditing module, and used for executing operations of the distributed auditing device.

6. The device according to claim 5, wherein the transmission module is further configured to place the condensed status code in a blockchain.

7. The device according to claim 5, wherein the hash function refers to a SHA series of hash function.

8. The device according to claim 5, wherein the hash tree refers to a f full hash binary tree.

9. A distributed auditing system, comprising:
a distributed auditing device according to any one of claims 5 to 8; and
a plurality of user ends for receiving the condensed status code and each of the plurality of slices and for feeding back to the distributed auditing device.

10. The system according to claim 9, wherein devices of the plurality of user ends comprise personal computers, notebook computers, tablet computers, servers, workstations, smartphones, set-top boxes or a combination thereof.
